(19) United States
(12) Patent Application Publication
(10) Pub. No.: US 2023/0069619 A1
(43) Pub. Date: Mar. 2, 2023

(54) METHOD FOR MONITORING A WORK SYSTEM AS WELL AS SYSTEM COMPRISING A WORK SYSTEM

(71) Applicant: Workaround GmbH, Munchen (DE)

(72) Inventors: Till NÖLLGEN, München (DE); Sebastian PETRUCH, München (DE); Matthias KIRCHNER, München (DE); Johannes HUTTER, München (DE)

(21) Appl. No.: 17/898,431

(22) Filed: Aug. 29, 2022

(30) Foreign Application Priority Data
Aug. 31, 2021 (DE) 10 2021 122 485.3

(51) Int. Cl. G01M 99/00; G05B 23/02

(52) U.S. Cl. CPC G01M 99/005; G05B 23/0221

(57) ABSTRACT

A method for monitoring a work system including a plurality of sensor mechanisms and a control system. The method includes creating sensor data as well as event data packets during operation by a user by way of the sensor devices, transmitting event data packets to a correlation module of a monitoring system, receiving context information by way of the correlation module, correlating event data packets with the context information by way of the correlation module and creating context records by way of the correlation module that are based on the event data packets correlated with the context information, creating a report on the state of the work system and/or on deviations from the previous operating sequence of the work system and/or including a system improvement by an analysis module based on the context records. Moreover, a system is shown.

### FIELD OF THE DISCLOSURE

The disclosure relates to a method for monitoring a work system as well as a system comprising a work system.

### BACKGROUND

Work systems by means of which complex processes are executed are known. Here, several process steps are normally executed by machines and other process steps by workers or users.

The machines may be industrial robots or devices that are wearable by the user, such as barcode readers.

The users may be instructed by wearable devices, such as barcode readers, so that they execute the step required at that time in the complex process correctly.

Examples of such work systems are assembly lines of complex products, such as cars, or large distribution warehouses.

However, the processes executed with work systems are usually designed at the drawing board without any practical feedback from real life or the factory buildings in which the processes are executed.

Although these processes are very efficient in theory, they thus contain more often than not hidden inefficiencies resulting from intended or unintended process deviations of the users or even the spatial conditions of the work system or factory building in which the work system is used.

Moreover, a plurality of machines ranging from wearable barcode readers to industrial robots usually are used, thereby making it possible to obtain data, but there are many data streams from different machines and from different process steps available simultaneously.

In addition, EDP systems of the user are only adaptable to the work system with great difficulty as these are usually extremely complex due to their deep integration in the respective company.

For example, U.S. Pat. No. 7,243,001 B2 discloses a system for creating a map of a distribution warehouse, Workers, termed “pickers”, collect the goods intended for distribution from different racks of the warehouse during operation. In doing so, the position of each worker is recorded at different times and the routes travelled by the workers is determined using this. The determined routes are then used to create a map of the warehouse, to detect changes in the warehouse and to compare the performance of a worker with the performance of other workers. However, the data collected is not placed in a larger context, but rather, the process is limited to comparisons of current measured values with historical measured values.

For these reasons, such work systems are difficult to monitor and to check for efficiency. Moreover, problems cannot be identified promptly.

### SUMMARY

Thus, there is a need to provide a method for monitoring a work system as well as a system that enables a monitoring of the work system as well as increases in the efficiency of the work system.

Therefore, a method for monitoring a work system is provided, comprising a plurality of sensor means that comprise at least a sensor and a control system. The method comprises the following steps:
creating sensor data as well as event data packets during operation by a user by means of the sensor means,
transmitting event data packets to a correlation module of the monitoring system,
receiving context information by means of the correlation module,
correlating event data packets with the context information by means of the correlation module and creating context records by means of the correlation module, said context records being based on the event data packets correlated with the context information,
transmitting context records to an analysis module, and
creating a report on the state of the work system and/or on deviations and/or with system improvements of the previous operating sequence of the work system based on the context records by the analysis module.

By creating the report on the state of the work system and/or on deviations from the previous operating sequence of the work system and/or the report comprising a system improvement, a monitoring of the work system can be facilitated similar to that of monitoring an automatic industrial plant so that it is possible to react quickly to problems emerging in the short-term.

Also, amendments can be recognised by considering deviations from the previous operating sequence which indicate hidden inefficiencies, whose remedy increases the efficiency of the work system, and corresponding proposals for improvement can be provided.

In contrast to the prior art, according to the disclosure not only current measured values are compared with past measured values, but a context can be used or generated that can be processed as a context record. In particular, the context can be determined by means of conditional probabilities.

For example, context records for different sensor means are used to create the report, i.e. a plurality of context records based on event data packets that are derived from different sensor means, in particular from sensor means of different users, different workstations and/or different activities.

For example, the sensor means can be worn, in particular as wearables, i.e. devices that are worn on the body or a garment.

In particular, the sensor data is transmitted to the control system or the monitoring system at the same time as the event data packets.

The context records can be regarded as a comprehensive description of a moment or section of the activity carried out by the user using the work system, in particular the processes executed.

In an embodiment, the control system controls the sensor means at least in part for the purpose of executing a process assigned to the respective sensor means, in particular wherein the assigned processes for different sensor means can differ. In this way, the user W can be guided particular effectively.

For example, said at least one sensor of the sensor means is a camera, a barcode reader and/or an acceleration sensor to make it possible to identify components or goods, places or persons simply.

A barcode can be, for example, a barcode, a QR codes, a data matrix code or suchlike.

The sensor means can comprise at least an actuating element, in particular a push button and/or a trigger, for simple actuation of the sensor or other components of the sensor means.

To be able to guide the user in a targeted manner, the sensor means can comprise at least one output means, in particular a screen, one or several LEDs and/or a speaker.

In an embodiment, the work system comprises a plurality of connection devices, wherein each connection device is connected to one or more of the sensor means via a wireless communication link and is connected to the control system via a wired or wireless communication link or is configured to the same device, in particular wherein the connection device controls the corresponding sensor means in part for the purpose of executing a process assigned to the sensor means. By using connection devices, the sensor means can be configured simply and, in particular, without performant processors, thereby enabling the sensor means to be particularly compact.

For example, the connection devices are part of the correlation module, thereby making it possible to use the capabilities of the connection devices effectively.

In an embodiment of the disclosure, the connection devices create event data packets and transmit these to the correlation module, in particular wherein an event data packet is created by one of the connection devices if there is a trigger event, in particular wherein the trigger event is the establishment of a connection of a communication link between one of the sensor means and the connection device, the connection end of the communication link between one of the sensor means and the connection device, the recognition of a high-priority event and/or exceeding or falling below a threshold value. As a result, the sensor data of the sensors of the connection devices can be included in the report, which makes this more accurate.

The threshold value is based on, for example, measured values of the sensors, such as temperature values, or the state of the device (e.g. more as x reboots in the last y hours).

In this case, the connection device may assume a double function if it initially creates an event data packet and at the same time correlates the event data packet with the context information in its function as part of the correlation module and generates at least one context record.

For example, an event data packet is created at regular intervals by the sensor means and/or an event data packet is then created if there is a trigger event and contains information on the trigger event, in particular wherein the trigger event is an actuation of the sensor means by the user, the expiry of a predetermined period of time, the occupancy of a queue, the establishment of a connection of a communication link between the sensor means and the connection device, the connection end of the communication link between the sensor means and the communication device, the recognition of a high-priority event and/or exceeding or falling below a threshold value. In this way, the activity of the user can be recorded precisely.

For example, the queue is a buffer queue, in which low-priority events are collected, such as telemetry data. High-priority events are, for example, the existence of error conditions, such as error functions of the firmware.

In an aspect of the disclosure, the event data packet comprises current sensor data of at least one sensor of the sensor means as well as at least one situation information of the sensor means, in particular wherein the current sensor data includes the number of steps carried out between two event points, the type of activity between two event points, the movement travelled between two event points, the length of time between two end points, gestures and/or a measured value of a sensor of the sensor means, in particular the value and/or the image of a captured barcode and/or an image of a camera, and/or the situation information includes information of the process step, in particular an identifier of the process step, an identifier of the corresponding sensor means, an identifier of the corresponding connection device, a time stamp, the current location, the state of charge of the storage battery or the primary battery of the sensor means, information on the connection quality between the sensor means and the connection device, information on the sensor means (serial number, manufacturer, model, software version), information on the connection device, the relative position of the sensor means to the connection device, the distance between the sensor means and the connection device, information on whether the connection device is mobile or stationary and/or an identifier of the configuration of the sensor means. As a result, the event data packets provide information beyond the actual sensor data, said information improving the quality of the report considerably.

The event points can be trigger events, in particular the actuation of the sensor means or the actuation of the actuation device.

To process collected data quickly and efficiently, in particular in real time, the event data packets, in particular the information in the event data packets, can be correlated with the context information by means of a machine learning module of the correlation module and/or can be correlated using the time stamp, the identifier of the corresponding sensor means, the identifier of the corresponding connection device, a user identifier, an identifier of the process step and/or information that the event data packet assigns to an event, an activity, a location and/or an object.

In an aspect of the disclosure, the report as state of the work system contains information on the setup of the work system, in particular stationary workstations of the work system; the utilisation of the work system, in particular the sensor means; the state of sensor means, gateways and/or connection devices; said at least one process executed with the work system, in particular individual process steps of the process, the sequence of individual process steps of the process, the length of individual process steps of the process, the process start and/or the process end; the discharge rate of the storage battery or the primary battery of the sensor means; the storage or primary battery life; the type of barcode being read; the duration of a reading process; the success of a reading process; the number of steps between two reading processes; the change of location between two reading processes; the software version of the sensor means; the software version of connection devices and/or information regarding the charging behaviour of the sensor means. By means of such a report, the work system can be analysed, in particular in real time, e.g. to discover hidden inefficiencies in the process.

The type or kind of barcode read (barcode, QR code, data matrix, etc.) is also termed symbology.

Information of the setup of the system can also describe the locations of the workstations, also the relative locations among each other.

Alternatively or additionally, the report as deviations from the previous operating procedure can contain information of sensor means comprising more or less executed process steps as the previous operating sequence; changes to the setup of the work system, in particular of stationary workstations of the work system; changes to the utilisation of the work system, in particular the sensor means; changes to the state of the work system, in particular the sensor means; changes to said at least one process executed with the work system, in particular individual process steps of the process, the sequence of individual process steps, the length of individual process steps, the process start and/or process end; differences between the same processes at different locations and/or workstations; and/or differences regarding industry reference values. Such a report facilitates, for example, a monitoring of the work system, in particular in real time, so that it possible to react to deviations quickly.

Industry reference values derive, for example, from external sources, such as market research reports, or other work systems.

The monitoring can be carried out in a way similar to the monitoring of an automated industrial system, for example in a control room.

To facilitate long-term analyses and comparisons with the past, the context records and/or event data packets can be stored in a storage device to be used at a later date as past context records and/or past event data packets, in particular wherein the report is created on the basis of current context records generated by the correlation module and past context records stored in the storage device.

For comprehensive and varied context information, the correlation module can contain context information from the control system, an inventory management system, an enterprise resource planning system, a machine controller of a machine of the system, a mobile device management system (MDM), data from external data providers and/or publicly accessible data sources.

For example, the context information contains information regarding the working environment, processes of the work system, users of the work system and/or the utilisation of the work system, in particular the temperature of the working environment, information on the usual workload in a working day, the expected utilisation, the dependences of activities among each other and/or the state of public health in the region of the work system. By means of the context information, the sensor data and the event data packets can thus be put in a wider context, in particular beyond the individual sensor means.

It is also conceivable that the context information is assessed by a user of the work system with respect to its relevance for the work system, in particular by a supervisor of the work system, such as an overseer or a shift planner. The correlation module may receive this assessment and weights or chooses the context information to be used to generate the context records differently based on the feedback.

In an embodiment of the disclosure, the report is transmitted to the control system, an inventory management system, an enterprise resource planning system, a mobile end device, a workplace computer and/or an output means, in particular wherein the output means is configured to output the report. This ensures as a result that the report can be located simply by the recipients of the report.

The mobile end device can be a smart device and/or a computer of a supervisor of the work system, such as an overseer or a shift planner. The transmission can take place per email, RSS feed, API access or suchlike.

In an embodiment, the analysis module receives the event data packets. The analysis module creates context information for the event data packets based on the event data packets and/or past event data packets and transmits the context information to the correlation module, in particular wherein the analysis module comprises a context machine learning module that creates context information for event data packets based on the event data packets and/or past event data packets. In this way, the context of the event data packets can be obtained from the event data packets themselves, for example from the sequence of event data packets by detecting patterns or through image recognition.

For example, the analysis module determines information as context information to an event data packet, the event data packet assigning said information to an event, an activity, a location and/or an object, in particular wherein the information contains a probability that the event data packet is to be assigned to the event, the activity, the location and/or the object. In this way, the context of the event can be described very precisely.

The determined probability is, in particular, a conditional probability.

In particular, an event, an activity, a location and/or an object is understood to mean both specific events, activities, locations and/or objects, such as “rack 5” or “receiving the windscreen” as well as categories of events, activities, locations and/or objects, such as “rack” or “receiving an object”.

In an embodiment of the disclosure, the analysis module determines at least one system improvement based on the context records, in particular the current context records and past context records, and/or the report, in particular wherein the system improvement is transmitted to the control system, an inventory management system, an enterprise resource planning system, a mobile end device and/or an output means. In this way, the monitoring system can improve the work system.

The output of the system improvement occurs, for example, together with at least one report. In this way, the supervisor receives an insight into the work system by means of the report and at the same time instruction on how the work system can be improved.

For example, the following steps are implemented to simplify the creation of the report.
determining the state of the work system, the previous operating procedure and/or deviations from the previous operating procedure on the basis of context records, and
creating the report using the state of the work system, the previous operating procedure and/or deviations from the previous operating sequence.

To process the collected data quickly and efficiently, in particular in real time, a first machine learning module of the analysis module can be used to determine the state of the work system, the previous operating procedure and/or deviations from the previous operating procedure, in particular wherein the first machine learning module comprises an artificial neural network, a decision tree, a statistical algorithm, a cluster algorithm, a module for text generation and/or a principal component analysis.

In an embodiment of the disclosure, a report template is used for creating the report, wherein the report template contains instructions for the analysis module in order to generate the report assigned to the report template using the context records. This simplifies the creation of the report.

For example, the report template indicates the input data required for the report and at least one analysis step for determining the state of the work system, the previous operating procedure and/or deviations from the previous operating procedure as well as optionally defines system improvements based on the results of at least one analysis step. In this way, the creation of the report can be simplified further.

The report template can indicate here from which sources the input data is obtainable.

To increase the meaningfulness of the reports, the report template can define at least one significance condition, wherein the analysis module is checked using the context records as to whether said at least one significance condition is fulfilled, wherein the report is only generated using the corresponding report template if the significance condition is fulfilled.

To create the report efficiently, the analysis module can select or generate a report template and create the report based on the report template and the context records.

The generation of the report template using the context records and the past context records can be carried out by means of a second machine learning module of the analysis module.

In an embodiment of the disclosure, the analysis module generates several report templates or selects several report templates, creates the report for each report template and assesses the relevance of the reports, wherein only that report of the created reports is reproduced which is most relevant or only a predetermined number of the created reports are reproduced which are most relevant. In this way, the number of reports can be reduced in order to not demand too much attention from the supervisor or other persons. At the same time, it ensures that the reports are relevant for the supervisor or other persons.

To process the collected data quickly and efficiently, in particular in real time, the analysis module can comprise a third machine learning module that assesses the relevance of the reports, in particular using feedback from the user, a supervisor and/or users of other work systems.

To simplify the reproduction of the report, the report template can specify a specification for the reproduction of the report, in particular regarding the device on which the report is to be displayed and/or the form of representation of the report.

In an embodiment of the disclosure, the system improvement is transmitted to a distribution module, wherein the distribution module creates at least one change order for at least one of the sensor means based on the system improvement and transmits the change order to the corresponding sensor means, the connection device corresponding to the respective sensor means and/or the control system, thereby ensuring an automatic adaption of the work system.

For example, the sensor means outputs an action order to the user on basis of the change order in order to change the activity of the user and thus the work system.

To change the work system as a whole, the control system and/or the corresponding connection device can change the process assigned to the corresponding sensor means based on the system improvement and/or instruct the sensor means to output an action order.

To process the collected data quickly and efficiently, in particular in real time, the machine learning module of the correlation module, the first machine learning module of the analysis module, a second machine learning module of the analysis module, a third machine learning module of the analysis module, a fourth machine learning module of the analysis module, the context machine learning module of the analysis module and/or a machine learning module of the distribution module can be or comprise an artificial neural network, a decision tree, a statistical algorithm, a cluster algorithm, a module for text generation and/or a principal component analysis.

The various machine learning modules can be configured as separate machine learning modules or one, several or all machine learning modules can be configured collectively. In this case, the information exchanged between the modules, e.g. the context data packets, can be latent variables.

Moreover, the object is solved by a system comprising a work system and a monitoring system, wherein the system is configured to execute a method previously described.

The features and advantages described for the method equally apply to the system and vice versa.

Moreover, all components of the system are configured and set up to also execute functions executed by them in the process.

### BRIEF DESCRIPTION OF THE DRAWINGS

Additional features and advantages of the disclosure are found in the following description as well as the attached drawings to which reference is made. In the drawings:

FIG. 1 shows a production building comprising a system according to the disclosure schematically,

FIG. 2 shows a user of the system with sensor means and connection devices of the system according to FIG. 1,

FIG. 3 shows a schematic view of a sensor device as a sensor means according to FIG. 2,

FIG. 4 shows a schematic diagram of the system for clarifying data flows,

FIG. 5 shows a second embodiment of the system according to the disclosure schematically,

FIG. 6 shows an example of a report created in the second embodiment, and

FIG. 7 shows an example of a further report in the display for the user.

### DETAILED DESCRIPTION

Lists having a plurality of alternatives connected by “and/or”, for example “A, B and/or C” are to be understood to disclose an arbitrary combination of the alternatives, i.e. the lists are to be read as “A and/or B and/or C”. The same holds true for listings with more than three items.

In FIG. 1, the factory building 10 is shown in an aerial perspective extremely schematically as well as a system 12 in an aerial perspective.

The system 12 has a work system 14 as well as a monitoring system 16.

The factory building 10 is, for example, a production building in which a product is produced. For example, the product is a vehicle or parts for this.

To produce the product, a predefined process comprising various process steps is to be executed which are executed by the workers, hereinafter termed users W.

It is conceivable that autonomous robots or drones are used as the user W instead of the worker.

To this end, different workstations 18 of the work system 14 are located in the factory building 10, at said workstations one or more of the process steps are executed.

In the shown embodiment, two production lines each comprising three workstations 18 are provided. The workstations 18 of a production line neighbour each other; in FIG. 1, they are perpendicular to each other.

The production lines are thus arranged parallel to each other.

In addition, the work system 14 comprises a control system 20, several connection devices 22 as well as several sensor means 24.

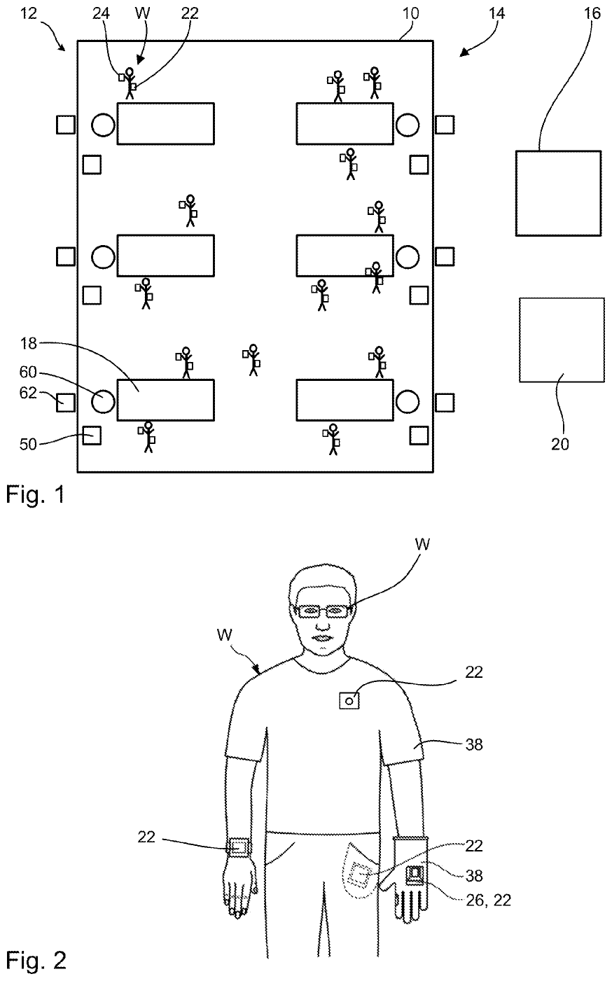

The sensor means 24 are worn by the users W. For example, each user W wears at least one or more sensor means 24, as shown in FIG. 2.

The sensor means 24 comprise a sensor 28 as well as optionally an output means 30 and an actuating element 32.

The sensor means 24 are, for example, headsets with a microphone as sensor 28 and headphones as output means 30. In addition, the headset can comprise a pushbutton as actuating element 32.

For example, a sensor means 24 can also be a camera, for example a helmet camera or a camera attached to a garment. The camera acts as the sensor 28 and optional screens, LEDs, loudspeakers or pushbuttons of the camera act as output means 30 or actuating element 32.

A barcode reading device can also be a sensor means 24, wherein the barcode reader of the barcode reading device is the sensor 28 and optional screens, LEDs, loudspeakers or pushbuttons of the camera act as output means 30 or actuating element 32.

Wearable sensor devices 26, as known as secondary devices in DE 10 2019 118 969 A1 or DE 10 2020 106 369 A1, can also be sensor means 24.

The sensor device 26 has a sensor 28, a screen as output means 30, a control unit 34 comprising a communication module 36 and a power storage medium, such as a storage battery.

The sensor device 26 also has an actuating element 32, for example in the form of a pushbutton or owing to the fact that the screen is configured to be touch sensitive.

The sensor device 26 is, in particular, a device whose function is limited to specialized applications. To this end, it can be an embedded system and/or have a compact form.

For example, the sensor device 26 is not a multi-functional device, thus is not a smart device, such as a smartphone, a tablet, a smart watch or smart glasses.

It is also conceivable that the sensor means 24 is a smart device, such as a smartphone, a tablet, a smart watch or smart glasses. The sensor 28 is, for example, an optical sensor, such as a barcode reader or a camera. It is also conceivable that the sensor device 26 as the sensor 28 comprises other sensor units, such as an RFID reader, touch sensors or acceleration sensors in addition to or instead of the optical sensor.

However it should be noted that this embodiment is purely exemplary for illustration purposes. Alternatively, the sensor device 26 can be designed without a screen.

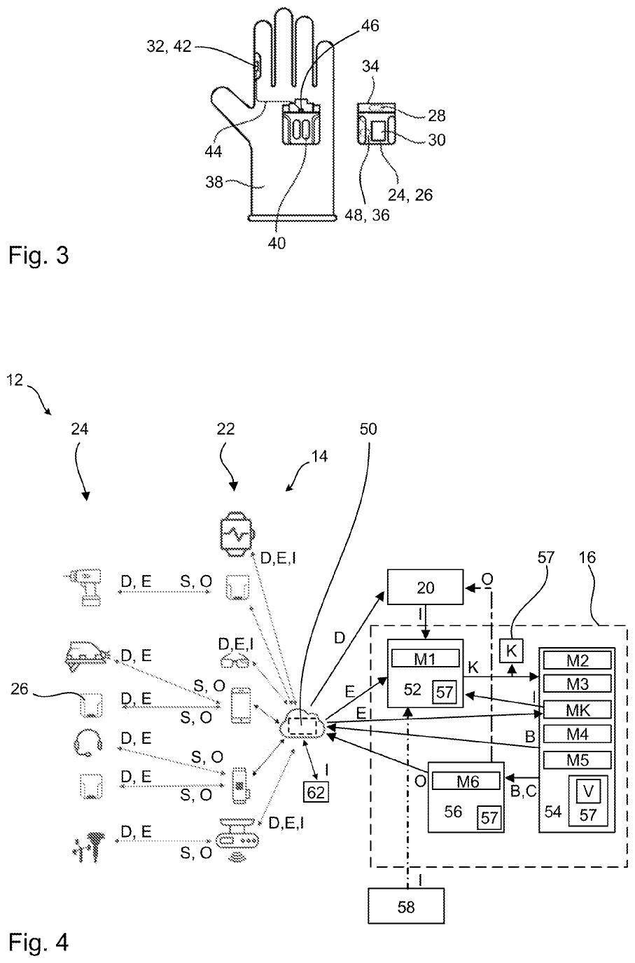

As can be seen in FIG. 3, the work system 14 has in addition a garment 38, in particular a glove, by means of which the sensor device 26 can be fastened to the body of the user W. The sensor device 26 or the combination of the garment 39 and the sensor device 26 is what is termed a “wearable”.

For this purpose, the garment 38 has a holder 40 in which the sensor device 26 can be fastened and removed without tools in a repeatable manner.

The garment 38 can also have an input means 42, for example a trigger for the sensor device 26. The trigger or the input means 42 can be provided on a finger of the glove. It is also conceivable that said at least one input means 42 or one or several further input means 42 are provided on the holder 40.

By means of at least one cable 44 and at least one contact 46 in the holder 40, the input means 42 is connected to the sensor device 26 as soon as the sensor device 26 is inserted in the holder 40.

The input means 42 on the garment 38 can thus also be regarded as an actuating element 32 of the sensor device 26.

However, stationary sensor means, such as temperature and wind gauges (FIG. 4), come into consideration as sensor means 24.

The sensor devices 26 all comprise a communication module 48, via which the sensor devices 26 are connected to the connection devices 22.

Sensor means 24, in particular the sensor devices 26, can be operated using different configurations to execute different tasks within the process. Through the configurations, the functions of the sensor means 24 are defined to allow the sensor means 24 the functionalities that are necessary for the respective process step.

The connection devices 22 are devices that typically have larger computing power as the sensor means 24, in particular the sensor devices 26. For example, the connection devices 22 are designed as smart devices, such as a smartphone, a tablet, a smart watch or smart glasses, or a wristband equipped with corresponding processors and communication modules. In this case, the connection devices 22 are also mobile and are worn by the user W.

The combination of the sensor device 26 and the connection device 22 corresponds to the example of the sensor and information system comprising a secondary device (sensor device 26) and main device (connection device 22) of DE 10 2019 118 969 A1 or DE 10 2020 106 369 A1.

It is however conceivable that stationary devices, such as base stations for wireless communication are used, e.g. WLAN access points or mobile base stations as connection devices 22, but also stationary devices that operate as WLAN clients. Connection devices 22 can also be connected per USB to a computer or the control system 20 and per wireless communication to the sensor means 24.

It is however conceivable that sensor means 24 is built into a device with the connection device 22.

The connection devices 22 maintain a communication link, on the one hand, with the control system 20 and, on the other hand, with the sensor means 24 assigned to them.

In doing so, several sensor means 24 can be assigned to one of the connection devices 22. For example, it is however not possible that a sensor means 24 is connected simultaneously to several connection devices 22.

The control system 20 is operated on one or more central computers and/or servers.

The control system 20 is, for example, an inventory management system, an enterprise resource planning system (ERP system) or suchlike and is used for monitoring, for quality management and optionally for controlling the processes of the work system 14, e.g. the processes for producing the product.

The control system 20 is connected directly or indirectly via a communication link to each of the connection devices 22 permanently or temporarily.

This communication link can occur wirelessly, wired or through a combination of these. For example, the connection devices 22 are connected, in particular if it is a mobile device, via wireless communication links to gateways 50 of the work system 14, wherein the gateways 50 have in turn a wired communication link to the control system 20, e.g. by means of LAN or the Internet. The gateways 50 are merely shown as dashed lines in FIG. 4.

The gateways 50 can be simultaneously connection devices 22 to which the sensor means 24 directly connect.

The monitoring system 16 comprises, as shown in FIG. 4, at least one correlation module 52, an analysis module 54, a distribution module 56 and at least one data storage 57.

The data storage 57 can be part of the correlation module 52, the analysis module 54 or the distribution module 56. Each of these modules 52, 54, 56 can also have a data storage 57.

The correlation module 52, the analysis module 54 and the distribution module 56 can be configured as applications on one or more central computers or servers. They have a communication link to each other for the purpose of data exchange.

In addition, at least the correlation module 52 and the distribution module 56 have a communication link to the connection devices 22 and/or the sensor means 24.

Simultaneously it is possible that one or more of the connection devices 22 even assume the functions of the correlation module 52 and thus are also to be regarded as at least part of the correlation module 52.

Similarly it is conceivable that one or more connection devices 22 execute the functions of the control system 20. Thus, the connection device 22 can be both part of the correlation module 52 as well as part of the control system 20. In addition it, is conceivable that a connection device 22 like a sensor means 24 also generates an event data packet E.

The user W works at various workstations 18 with the help of the sensor means 24 in order to produce the product. In FIG. 4, the data flow is shown schematically during the work of the user W.

While the user W at one of the workstations 18 executes the process steps belonging to this workstation 18, the user W uses the sensors 28 of the sensor means 24 or the sensors 28 are activated automatically.

For example, before installing a component on the product, the worker W must capture a barcode of the product by means of the sensor 28 of the sensor device 26. To read the barcode, the worker W triggers, for example, the sensor 28 by actuating the input means 42 on the garment 38.

As a result, sensor data D is generated, in the described example the value of the barcode, an image of the barcode or the entire image recorded by the barcode reader.

Further examples for sensor data are accelerations, given acceleration patterns, for example, steps, movement sequences, such as turning movements of the hand for tightening bolts, or gestures, scanned RFID tags and/or temperature measurements.

The sensor data D generated by the sensor means 24 is then transmitted to the connection device 22. The connection device 22 transmits the sensor data finally on to the control system 20. This can take place by means of device-internal transmissions provided that parts of the control system 20 are configured on the connection device 22.

The control system 20 can guide or control the sensor means 24 at least in part to execute a process or process steps, in particular, this is the process or are the process steps that were assigned to the corresponding workstation 18 or even the exact sensor means 24. To this end, the different sensor means 24 of a process or process steps assigned to a user W may differ.

For example, the control system 20 now checks the obtained sensor data D, thus in this case the barcode, with the intended process steps that are executed in the factory building 10 or at the special workstations 18.

In the control system 20, the processes and process steps are stored so that the control system 20 already expects certain sensor data from the sensor means 24. The control system 20 can now compare the obtained sensor data D with the expected sensor data and provide feedback as the result of the comparison.

Moreover, the control system 20 can transmit a control instruction S to the same or another sensor means 24 in order to guide the user W. For example, the user W can be informed about whether the user W wants to mount the correct component or whether the correct barcode has been read. The user W can also be transmitted further information by means of the output means 30. To this end, the control instruction S comprises, for example, information, in particular text, that is to be shown on the screen of the sensor device 26.

The control instruction S has been transmitted from the control system 20 to the corresponding sensor means 24 by means of the gateway 50 or the connection device 22.

The corresponding sensor means 24 receives the control instruction S and executes the instructions contained in control instruction S.

The user W can then transfer to the next process step or execute these if other instructions are being communicated.

To this end, the connection device 22 can assume all or parts of these activities of the control system 20 for the purpose of information and guidance of the user W. This is disclosed, for example, in DE 10 2019 118 969 A1 or DE 10 2020 106 369 A1.

In this way, the user W will generate further sensor data D continuously while working.

In addition to the sensor data D that is transmitted to the control system 20, the sensor means 24 also generate event data packets E that are intended for the monitoring system 16 and not for the control system 20.

An event data packet E is generated by the corresponding sensor means 24 and contains in addition to current sensor data D, for example the sensor data D that is also transmitted to the control system 20, at least one further information that is referred to a situation information A within the scope of this disclosure.

An event data packet E thus contains more information as the sensor data D, in particular such information that describes in more detail the factors or the context under which the sensor data D has been generated.

Both the sensor data D as well as the situation information A can be very different information.

For example, the current sensor data D can be the number of steps carried out between two event points, the type of activity between two event points, the movement travelled between two event points, the length of time between two end points and/or a measured value of a sensor 28 of the sensor means 24.

For example, this may be an image of a camera that shows the sensor 28, the value or the image of the captured barcode, measured values of acceleration sensors, movements recognised by means of acceleration sensors, such as steps or gestures.

For example, an event point is the actuation of the sensor means 24 by means of the actuating element 31.

The situation information A, however, describes the situation in which the sensor data D has been collected. For example, it contains details of the process step in which the sensor data D has been generated.

The situation information A can contain, in particular, information regarding the used sensor means 24 that created the event data packet E. For example, it is conceivable that the current location, an identifier of the sensor means 24, the state of charge of the storage battery or primary battery of the sensor means 24, information on the sensor means 24, such as the serial number, the manufacturer, the model or the software version, an identifier of the executed process steps and/or an identifier of the configuration of the sensor means 24.

The situation information A can however also contain information on the connection device 22, by means of which the sensor means 24 communicates with the control system 20 or the monitoring system 16. For example, this information contains the location, an identifier of the connection devices 22, information on the connection quality of the communication link between the sensor means 24 and the connection device 22, information on the connection device 22 (serial number, manufacturer, model, software version), information on the connection device 22, the relative position of the sensor means 24 in relation to the connection device 22, the distance between the sensor means 24 and the connection device 22 and/or information on whether the connection device 22 is mobile or stationary.

This situation information A can be added by the connection device 22 to the event data packet E coming from the sensor means 24 and/or the sensor means 24 can receive this information from the connection device 22 and add it to the event data packet E.

As additional situation information A, the connection devices 22 can also add an identifier of the user W to the event data packet E if the user W has logged on to the connection device 22 or has been otherwise authenticated.

It is also conceivable that the situation information A contains a time stamp of the time at which the event data packet E and/or the sensor data D have been generated.

An identifier is understood to mean an identification that is uniquely determined for the corresponding device or configuration. For example, this identification is an alphanumeric character string.

The event data packet E is created by each of the sensor means 24 at regular intervals.

Alternatively or additionally here, the event data packets E can also be created if there is a trigger event.

A trigger event is an event in the course of the process, a predefined action to the sensor means 24, a predefined location change of the sensor means 24, such as leaving a certain area, and/or actuation of the sensor means 24 in a predefined way.

A trigger event is, for example, an actuation of the sensor means 24 using the actuating element 32 or using another way by the user W, for example, to record a measured value with the sensor 28 of the sensor means 24.

The expiry of a predefined period after an actuation or another trigger event can also constitute a further trigger event.

Predefined threshold values can also be specified for the measured values of the sensors, said threshold values being exceeded or falling below these threshold values constitute a trigger event. For example, the number of steps that can be determined by means of the acceleration sensor as sensor 28 and can be stored as threshold value, wherein a trigger event exists if the predefined number of trigger events is exceeded.

It is also conceivable that exceeding a predefined acceleration threshold value constitutes a trigger event in order to be able to document, for example, falls and thus occupational accidents.

The measured values of a temperature sensor of the sensor means 24 may also be used. For example, exceeding a predetermined temperature can indicate that the user W has gone in a cooled room. This is also shown as a trigger event.

Properties of the communication link to the connection device 22 can also constitute trigger events, such as the establishment of the connection between the sensor means 24 and the corresponding connection device 22 or the connection end.

Trigger events can also be defined in the software of the sensor means 24, for example the occupancy of a queue, such as a buffer queue, in which low-priority events are collected such as telemetry data. If the queue reaches a specified length, there is a trigger event.

This can constitute individual, high-priority events, such as the presence of error conditions that constitute a trigger event.

These trigger events can constitute previously described event points.

It is conceivable that the event data packets E always contain certain situation information An independent of the sensor data D, such as the identifier of the sensor means 24. It is conceivable that another situation information A is only then recorded in an event data packet E if certain sensor data D is also contained in the event data packet E.

In particular, the event data packets E, irrespective of their source or their content, have an identical setup and/or an identical structure, thereby making it possible to be processed further by a machine learning module, in particular an artificial neural network.

The event data packets E that have been generated by the sensor means 24 are forwarded to the connection devices 22 and the correlation module 52 of the monitoring system 16.

The correlation module 52 of the monitoring system 16 thus contains the event data packets E of the sensor means 24 and the connection devices 22.

The sensor data D and the event data packets E are transmitted, for example, simultaneously to the control system 20 and to the correlation module 52.

Before, simultaneously or subsequently, the correlation module 52 also receives the context information I from further sources.

The context information I, similar to the situation information A, provides further information on the situation in which the sensor data D has been generated. In contrast to the situation information A, the context information I is limited however non-specifically and in particular not to a given sensor means 24 or the given connection device 22 that created the event data packet E. Rather, they can be universal.

For example, the context information I solely contains information from external sources, i.e. sources that are not a sensor means 24 or a connection device 22, in particular not part of the work system 14, and/or context information from the analysis module 53, in particular information that assigns the event data packet E to an event, an activity, a location and/or an object, for example a probability that the event data packet E corresponds to the event, the activity, the location and/or an object.

The determined probability is, in particular, a conditional probability.

In particular, the context information I does not include or not only include statistical and/or spatial findings (such as average travel time between two points) that have been obtained from the event data packets E.

The context information I comprises, for example, information on the working environment, for example on the factory building 10 and/or the arrangement of workstations 18. This is for example the temperature of the working environment, in this case, the temperature in the factory building 10. Also the state of public health in the region of the work system 14 or the factory building 10 can be such context information I.

The context information I can also contain information on processes of the work system, such as details of individual process steps and/or the sensor data D anticipated in a process step by the sensor means 24 and/or the dependences of activities among each other in a process step.

Also information on the users of the work system 14 can be context information I, such as the number of users who are currently executing a certain process or process step. An identifier of a specific user W can also be context information, for example, if the user W must login on the control system 20 or must be authenticated.

The utilisation of the work system 14 can belong to the context information I, such as information on the usual workload in a working day and/or the current time, the expected degree of utilization at the current time or suchlike.

This context information I is transmitted to the correlation module 52 by external data sources 58 that are connected to the correlation module 52 for the purpose of data exchange, particularly via the Internet.

The external data sources 58 can be the control system 20, an inventory management system, an enterprise resource planning system, machine controller 62 of a machine 60 of the system 12, in particular a work system 14, a mobile device management system (MDM), a database of an external data providers and/or publicly accessible data sources, such as from official authorities.

The machine 60 is, for example, an industrial robot (FIG. 1) or a conveyor belt that is arranged in the factory building 10 in particular.

It is also conceivable that one or more connection devices 22 form part of the correlation module 52 themselves and accordingly execute the functions described in the following at least partially.

It is thus conceivable that the connection devices 22 have a double function or even a triple function if they collect sensor data D and create event data packets E that control the sensor means 24 similar to the control system 20 and also act as part of the correlation module 52.

The correlation module 52 correlates the information of event data packets E with the context information I, thereby making it possible to put the event data packet E, in particular the sensor data D, into a larger context by means of the content context information I.

For this purpose, the correlation module has a machine learning module M1. The machine learning module M1 of the correlation module 52 is or comprises, for example, an artificial neural network, a decision tree, a statistical algorithm, a cluster algorithm, a module for generating text and/or a principal component analysis. In the case of an artificial neural network, this is trained using training data that contains the input data for various situations and information on the expected and correct output of the artificial neural network on the basis of the input data. The procedure of the training will be described later.

The training data records for the machine learning module M1 of the correlation module 52 contain event data packets E and context information I as input data as well as the corresponding context records K as information on the correct output.

Using the machine learning module M1, the correlation module 52 correlates the event data packets E with the context information and generates context records K. For example, the correlation module 52 correlates the event data packet E and the context information I using the time stamp (that can also be comprised in the context information), at least one shared identifier, such as the identifier of the sensor means 24, the identifier of the connection device 22, the identifier of the user W or an identifier of the process step.

The identifier of the user can, for example, be obtained owing to the fact that it is known by the monitoring system 16, which user W uses which connection device 22 or which sensor means 25 as the user W must login before and be authenticated.

Different process steps can also have an identifier for simple processing.

In particular, the correlation on the time stamp is simple to realise in very general context information I as information on the weather and/or the temperature of the working environment.

The correlation module 52 can also generate a context record K using the context information I of the analysis module 54, i.e. using the information that the event data packet E assigns to an event, an activity, a location and/or an object.

The context records K thus describes a moment or section of the activity executed by the user W with the work system 14, in particular the executed process extremely comprehensively, for example, beginning from the sensor data D generated at this moment and information on how this sensor data D was generated—contained as situation information A in the event data packet E—up to further, in part general information on the circumstances or placement in the entire process using the context information I.

In particular, the context records K have an identical setup and/or an identical structure, irrespective of their source or their content, thereby enabling them to be processed further by a machine learning module, in particular an artificial neural network.

As simple example, each context record K can indicate a time, an activity and a user who has executed this activity in a data format that is the same for each context record K. Here, it is irrelevant for the format of the context record K from which source the event data packet E and the context information I derive.

In this way, a uniform timeline of events or activities can be determined although the activities are executed or recorded with different types of sensor means 24.

It is conceivable that the context information I is assessed by a user of the work system 14, in particular a supervisor of the work system 14, such as an overseer or a shift planner whether and to what degree the context information I is relevant for the work system 14.

This assessment is transmitted to the correlation module 52 as feedback, and correlation modules 52 regards the received feedback when generating the context record K. For example, the correlation module 52 changes the weighting of context information I based on the feedback or chooses different context information for generating the context record K. For example, specific context information may be disregarded altogether if the received feedback indicates little relevance.

The context records K generated in this way are transmitted to the analysis module 54 of the monitoring system 16.

At the same time, the context records K can be stored in the data storage 57 of the monitoring system 16 in order to be used at a later date as past context records K. The analysis module 54 has access to the data storage 57.

The data storage 57 can be part of the correlation module 52, the analysis module 54 or the distribution module 56.

Similarly, the event data packets E can be transmitted to the analysis module 54 and/or stored in the data storage 57 of the monitoring system 16 in order to be used at a later date as past context records K. The analysis module 54 has access to the data storage 57.

The analysis module 54 can assign the current event data packet E to an event, an activity, a location and/or an object based on the event data packet E and the past event data packets E.

To this end, an event, an activity, a location and/or an object are understood to mean both specific events, activities, locations and/or objects, such as “rack 5” or “receiving the windscreen” as well as categories of events, activities, locations and/or objects, such as “rack” or “receiving a component”.

For this purpose, analysis module 54 can infer from the event, the activity, the location and/or the object that this is to be assigned to the current event data packet E on the basis of past event data packets E using the frequency, times and/or the environment (i.e. further event data packets E briefly temporally connected), in which similar past event data packets E occurred.

It is also conceivable that the actual event data packets E as sensor data contains an image file and/or recording of a movement and the analysis module 54 determines the event, the activity, the location and/or the object, which is to be assigned to the current event data packet E, through pattern recognition in the image file and/or recording of the movement.

For example, a probability is determined by the analysis module 54 that indicates whether the assignment of the event data packet E to the event, the activity, the location and/or the object is correct.

The determined event, activity, location and/or object and if applicable the value of probability are transmitted as context information I to the respective event data packet E to the correlation module 52.

To determine this context information I, the analysis module 54 can show a context machine learning module MK that includes an artificial neural network, a decision tree, a statistical algorithm, a cluster algorithm, a module for generating text and/or a principal component analysis. In the case of an artificial neural network, this is trained using training data that contains the input data for various situations and information on the expected and correct output of the artificial neural network based on input data. The procedure of the training will be described later.

The training data records for the context machine learning module MK of the analysis module 54 contain, for example, a set of event data packets E and optionally past event data packets E and the anticipated context information I as information on the correct output.

The context machine learning module MK or part of the analysis module 54 that determines the context information I, can also be designed separately from the analysis module 54, for example as part of the correlation module 52 or a separate context module.

Based on the context records K, in particular solely based on the context records K, the analysis module 54 now creates a report B on the state of the work system 14 and/or on the deviations from the previous operating procedure of the work system 14.

To prepare the report B, the analysis module 54 refers to a plurality of context records K that are each based on event data packets E which have been generated by different sensor means 24, in particular have been carried out by the sensor means 24 of different users W at different workstations 18 and/or in different activities.

The operating procedure is understood to be mean the actual activities and actions of the user W, for example in the ways in which the process is executed. It is certainly possible that the same process or at least individual process steps can be executed in two different ways (thus by two different operating procedures). Operating procedures also include errors and inefficiencies in the activities that are not intended in the process.

To this end, the current context records K are used that have been transmitted to the analysis module 54 within a predefined period of time, for example in the last half hour or the current working day. It is also conceivable that analysis module 54 uses the context records K stored in the data storage 57.

The analysis module 54 can also use previous reports B.

The results and/or data representations of the machine learning modules M1 to M6 as well as MK can be saved as historical results and/or data representations in the data storage 57 in order to use them later as a reference, for example by other parts of the analysis module 54.

To this end, the analysis module 54 has a first machine learning module M2 that is or comprises, for example, an artificial neural network, a decision tree, a statistical algorithm, a cluster algorithm, a module for generating text and/or a principal component analysis. In the case of an artificial neural network, this is trained using training data that contains the input data for various situations and information on the expected and correct output of the artificial neural network based on input data. The procedure of the training will be described later.

The training data record for the first machine learning module M2 of the analysis module 54 contain, for example, a set of context records K, optional past context records K and/or old reports B, and the expected reports B matching the context records as information on the correct output K.

For the creation of the report B, the analysis module 54 initially determines, for example, the state of the work system 14 and the previous operating procedure.

Using the context records K, the analysis module 54 can determine, for example, the setup of the work system 14. Thus, the number and positions of the workstations 18 can be determined using location data.

The activities executed at the respective workstations 18 can also be determined, for example using the data of the acceleration sensors, images of the camera or values of the barcodes read there.

The position of the workstations 18 among each other can also be indicated relative to each other, for example as a spacing of two workstations 18 in increments.

In addition to and instead of the workstations 18, any other locations of the work system can be recorded, such as doors and gates.

Even the condition of individual components of the work system 14, for example the sensor means 24, the connection devices 22 or the gateways 50 can be determined by the analysis module 54 as part of the state of the work system 14.

This includes, for example, the discharge speed of the storage battery or a primary battery of the sensor means 24, the storage or primary battery life of this, suspected damage due to rapid acceleration or suchlike. Even information on the software versions of the sensor means 24 or the connection devices 22 as well as information on the charging behaviour of the sensor means 24 may be part of the determined state.

Even the operating procedures in the work system 14, such as activities undertaken at certain locations, the division of the activities into smaller steps, the sequence of activities and suchlike can be determined by the analysis module 54 using the context records K.

Using the operating procedures, the analysis module 54 can also determine the process executed with the work system 14. Here, it is possible that the analysis module 54 also determines the individual process steps of the process, the sequence of the individual process steps of the process, the length of the individual process steps, the process start and/or the process end, in particular solely using the context records K.

Even the utilisation of the work system 14, in particular the individual sensor means 24, can be part of the information obtained by the analysis module 54, for example, using the number of measurements triggered by means of the sensor 28.

In the use of sensor means 24 with barcode readers as sensors 24, the type of read barcodes (also termed “symbology”) can be determined as well as the duration of a reading process, the success of the reading process, the success rate of the reading processes, the number of steps between two reading processes or the change in location between two reading processes.

Both the determined state of the work system 14, such as the setup of the work system 14 and also previous operating procedures and processes as well as all information obtained from the analysis module 54 can be stored in the data storage 57 by the analysis module 54 for later use.

The information and operating procedures stored in the data storage 57 are used by the analysis module 54, for example, to recognise deviations in the operating procedure.

The analysis module 54 can also use past reports B and results of historical analyses that were generated by the machine learning modules M1 to M6 as well as MK. For example, historical sensor data (e.g. barcodes) can be used in order to make via vectors probability predictions on the significance of the same barcodes in the future (e.g. the barcode is a location in the warehouse or the barcode represents a product group). In this regard, conditional probabilities are used for example.

To this end, the operating procedure determined by the analysis module 54 as a result of current context records K is compared to a previous operating procedure that has been stored in the data storage 57. Deviations from the previous operating procedure result from this comparison.

For example, deviations in the operating procedure may be due to the fact that the worker behaves differently or—if no information on the process is contained in the context information I—the process has amended.

All information that is determined by the analysis module 54 can be part of the report W.

The report B can contain textual information, numerical information and/or graphic components that visualise for example the setup of the work system 14.

The report B on the state of the work system 14 contains for example information on the setup of the work system 14, in particular information on the stationary workstations 18, their position in the factory building 10 and/or the position of the workstations 18 in relation to each other. If applicable, the distance can only be indicated, for example in increments, between the workstations 18. In addition to and instead of the workstations 18, any other locations of the work system can be recorded, such as doors and gates.

Even the state of the individual components of the work system 14, for example the sensor means 24, the connection devices 22 or the gateways 50 can be part of a report B, such as the discharge speed of the storage battery or a primary battery of the sensor means 24, the storage or primary battery life, suspected damage due to rapid acceleration or suchlike.

Similarly, the process executed with the work system 14 can be part of the report that the analysis module 54 has determined using the context records K. In this regard, it is possible that the analysis module 54 can also determine the individual process steps of the process, the sequence of individual process steps of the process, the length of individual process steps of the process, the process start and/or the process end alone using the context records K and thus can become part of the report B.

Even the utilisation of the work system 14, in particular the individual sensor means 24 can be part of the report B, for example, using the number of measurements triggered by the sensor 28.

In using barcode readers as sensors 28, the type of barcode read can be part of the report B, the duration of a reading process, the success of a scanning process, the rate of success of reading processes, the number of steps between two reading processes and/or the change of location between two reading processes.

Figuratively speaking, the report B on the state of the work system 14 can contain both, on the one hand, information regarding the basis setup of the work system 14, for example similar to circuit diagrams or construction plans of industrial systems. At the same time, the state or the utilisation of the work system 14 can be contained in the report B, similar to the reports that are used in control rooms for monitoring industrial systems.

The report B on the state of the work system 14 can also contain the operating procedure, i.e. the implementation of processes to be executed.

The report B can also be a report on deviations from the previous operating procedure, for example if it has been determined that deviations in individual process steps or procedures have occurred that have not occurred in the past although the process of the work system 14 is actually unchanged.

For example, the report contains information on sensor means 24 with more or less executed process steps or reading processes as in previous operating procedures, changes in the setup of the work system 14, in particular from stationary workstations 18 of the work system 14. Even changes to the utilisation of the work system 14, in particular sensor means 24 are to be regarded as deviations from the previous operating procedure.

It is also conceivable that the process has changed, with which the work system 14 is executed what also represents a deviation from the previous operating procedure, i.e. actual activities of the user W in the factory building 10. The amendments of at least one process can be in particular the changes to individual process steps, the sequence of individual process steps, changes to the length of individual process steps, changes to the process start and/or changes to the process end.

It is also conceivable that deviations from previous operating procedure are to be regarded not only temporarily but also locationally. For example, if the same processes or the same process steps of the process are executed at two workstations 18, which are however different from the operating procedures of both workstations 18, this can be information included in the report B.

The report B can also show deviations and differences from industry reference values.

A report template V can be used to create the report B.

A report template V contains, for example, instructions for the analysis module 54 on how the report B assigned to the report template V is to be generated using the context records K.

The report template V can also contain a specification for the reproduction of the report B. This specification can be, for example, on which device the report is to be displayed, the form of representation in which the report B is to be displayed in the report B and/or the time that is to be displayed in the report B.

This can be done owing to the fact that the report template V defines the input data required for the report B, i.e. context records K with specific sensor data D, so that the analysis module 54 only uses such context records K with the same sensor data D for the creation of the report B.

The report template V can also indicate an analysis step on how the state of the system, the previous operating procedure and/or deviations from previous operating procedure are to be determined using the input data.

To this end, the report template V can also indicate the source from which the input data is obtainable.

In addition, a report template V can contain at least one significance condition that must be fulfilled so that the analysis module 54 generates a report B using this report template V. The significance condition relates to the context records K and can thus be checked by the analysis module 54 using the context records K.

The significance condition indicates, for example, how many context records K must be present so they can be used as a basis for this specific report B. In this way, is possible to prevent reports B that are created that are not meaningful as the statistical population on which they are based would be too small.

The analysis module 54 selects a report template V for creating a report B. To this end, the report templates V are stored, for example, in the data storage 57 or in the analysis module 54.

It is also conceivable that the analysis module 54 generates a report template V, for example, using past context records K and current context records K by means of a second machine learning module M3 of the analysis module 54.

The second machine learning module M3 of the analysis module 54 is or comprises, for example, an artificial neural network, a decision tree, a statistical algorithm, a cluster algorithm, a module for generating text and/or a principal component analysis. In the case of an artificial neural network, this is trained using training data that contains input data for various situations and information on the expected and correct output of the artificial neural network on the basis of input data. The procedure of the training will be described later.

The training data record for the second machine learning module M3 of the analysis module 54 contain context records K as input data, which can both show current as well as past context records K, and the matching report template V as information about the correct output.

Using the selected or generated report template V, the corresponding report B is then generated by the analysis module 54, in particular the first machine learning module M2 of the analysis module 54.

It is also conceivable that several report templates V are selected or generated and a report is created for each report template provided the significance condition is fulfilled. Subsequently, the relevance of each of the created reports B is assessed.

The relevance of the report B can be assessed, for example, by the analysis module 54 itself.

To this end, the analysis module 54 comprises a third machine learning module M4. In addition to the reports B, this machine learning module M4 can also particularly rely on the feedback of the user, in particular the supervisor or other users of other work systems.

In particular, the third machine learning module M4 can improve continuously by assessing the feedback of users W who have been shown the report, in particular supervisors, and by adapting the assessment of relevance for future reports using the feedback.

The third machine learning module M4 of the analysis module 54 is or comprises, for example, an artificial neural network, a decision tree, a statistical algorithm, a cluster algorithm, a module for generating text and/or a principal component analysis. In the case of an artificial neural network, this is trained using training data that contains the input data for various situations and information on the expected and correct output of the artificial neural network based on input data. The procedure of the training will be described later.

The training data record for the third machine learning module M4 of the analysis module 54 contain reports B and feedback from users and supervisors on these reports B as input data as well as the relevance of the report B as information on the correct output.

Finally, a predefined number of reports B are selected from the created reports B and reproduced, namely those reports are the most relevant. For example, only one single report B, namely the report with the highest relevance is reproduced.

The report B received in this way or the reports B received in this way can now be transmitted for documentation or assessment, for example, to a control system 20, an inventory management system or an ERP.

It is also conceivable that the report is transmitted to a mobile end device, a workplace computer and/or another output means in order to display the report.

The mobile end device, the workplace computer and/or the other output means belong to a supervisor, such an overseer or a shift manager of the work system 14. The transmission can occur per email, RSS feed, API access or suchlike.

The mobile end device can be, for example, a smart device, such as a smartphone, a tablet, a smart watch or smart glasses. A headset or another headphone for acoustic output is conceivable as mobile end device.

In this way, it is possible for the supervisor to monitor the state of the work system 14 as well as any deviations in operating procedure and to initiation countermeasures. There are also here analogies to industrial systems that are monitored in a control room.

In addition to the report, the analysis module 54 can also determine a system improvement C. The system improvement C can be determined on the basis of context records K, in particular current context records K and past context records K, and the reports B.

Here, a system improvement C can be a measure on how the work system 14, can be changed, for example its setup or the process executed with in, can be improved in order to bring about improvements. In doing so, the work system 14 can be improved with regard to efficiency and/or utilization.

To determine the system improvement C, the analysis module 54 can comprise a fourth machine learning module M5. The fourth machine learning module M5 of the analysis module 54 is or comprises, for example, an artificial neural network, a decision tree, a statistical algorithm, a cluster algorithm, a module for generating text and/or a principal component analysis. In the case of an artificial neural network, this is trained using training data that contains the input data for various situations and information on the expected and correct output of the artificial neural network based on input data. The procedure of the training will be described later.

The training data record for the fourth machine learning module M5 of the analysis module 54 contains context records K and reports B as input data and system improvements C matching these as information on correct output.

For example, the system improvement C contains a measure for another arrangement of the workstations 18, for grouping several workstations 18 or to close redundant workstations 18.

Even the use of other barcodes in the work system 14 or barcodes of another size can be proposed, for example, if it has been recognised that the reading process of certain barcodes takes a particularly long time, for example in comparison to an industry reference value.

The system improvements C can already be contained in the report template V and be assessed during the creation of the report B on the basis of the corresponding template V, for example on the basis of the results of an analysis step defined in the report template V.

The system improvement C can be described, forwarded and issued together with the report B as described in the report.

However, the system improvement C cannot just be issued. Alternatively or additionally, the system improvement C can be transmitted to the distribution module 56 of the monitoring system 16.

Based on the system improvement C, the distribution module 56 then determines which parts of the work system 14 are to be changed and takes appropriate measures.

For example, the distribution module 56 determines which sensor means 24 must fulfil another function after the implementation of the system improvement C and determines change orders O for these sensor means 24.

The change orders O are then transmitted to the corresponding sensor means 24 using the connection device 22. It is also conceivable that the change orders O are transmitted to the control system 20 and transmitted from there to the respective sensor means 24.

The corresponding sensor means 24 contains the corresponding change order O and implements the change order O.

For example, the change order O contains an amended configuration or instructs the sensor means 24 to use another configuration. This is then implemented by the sensor means 24 so that the mode of operation of the sensor means 24 and thus the work system 14 changes.

The amended configuration may comprise an indication about the working distance most often used to read barcodes with the sensor means 24. This way, for sensor means 24 allowing a wide range of working distances, the correct working distance may be set prior to the reading process. As a consequence, the sensor means 24 does not have to sample the entire range of working distances with the barcode reader in order to read a barcode so that the reading process is sped up.

It is conceivable that different working distances for different locations are included in the amended configuration, even if the barcodes at the different locations are read with the same sensor means 24.

It is also conceivable that the distribution module 56 determines that a certain user W of the work system 14 is to be deployed at another location, for example at another workstation 18 in order to implement the system improvement C.

In this case, a change order O is also transmitted to a sensor means 24 or a connection device 22, namely the connection device 22 or the sensor means 24 currently being used by that user W who is to change locations.

In this case, the change order O contains an action order for the user W and is transmitted to the corresponding sensor means 24 via the connection device 22.

The connection device 22 and/or the sensor means 24 of the user W who is to change location, then outputs an action order to the user W based on the change order O received. For example, this can occur by means of the output means 30 of the sensors means 24. For example, a corresponding text is shown on the smart device (connection device 22) or the screen of the sensor device 26 (sensor means 24).

This message instructs the user W to go to another given workstation 18 and to continue to work there.

At the same time, the sensor means 24 can be adapted to the task at the new workstation 18 by the change order O, for example by changing the configuration.

In another embodiment, it is also possible that the distribution module 56 indirectly influences the plurality of sensor means 24, in which it instructs the control system 20 and/or the connection device 22 assigned to the corresponding sensor means 24 by means of a change order O or another suitable message that change the process assigned to the sensor means 24.

It is also conceivable that the distribution module 56 changes the process of the work system 14, for example by outputting a change order O to the control system 20.

To fulfil the described functions at least in part, the distribution module 56 can comprise a machine learning module M6.

The machine learning module M6 is or comprises, for example, an artificial neural network, a decision tree, a statistical algorithm, a cluster algorithm, a module for generating text and/or a principal component analysis. In the case of an artificial neural network, this is trained using training date, the input data for various situations and information on the expected and correct output of the artificial neural network based on input data. The procedure of the training will be described later.

The training data records for the machine learning module M6 of the distribution module 56 contains a system improvement C as input data as well as a change order O and recipient, for example the exact sensor means 24, of the change order O as information on the correct output,

By means of the monitoring system 16, it is thus possible to monitor a work system 14, in which many different sensors means 24 are used that are worn and deployed partially, in particularly predominately by the user W.

The monitoring system 16 enables, in particular, a monitoring for the work system 14 similar to an industrial system in which a fully automated process takes place.

At the same time, it is also possible that the monitoring system 16 determines the setup of the work system 14 and recognises the processes and individual process steps executed with the work system 14.

Moreover, the monitoring system 16 enables the improvement of the work system 14 by generating system improvements C on how the work system 14 can be improved. These system improvements C can also be implemented independently using the distribution module 56, in which the sensor means 24 are controlled accordingly. In this way, feedback to the individual sensor means 24 takes place which is similar to a feedback control.

One, several or all the artificial neural networks described in the machine learning modules M1 to M6 as well as MK can be trained using the described training data. The method comprises the following steps:
feed forward—the input data through the artificial neural network,
determining the response output of the artificial neural network based on the input data.
determining an error between the response output of the artificial neural network and the expected correct output of the artificial neural network, and
changing weighting factors of the artificial neural network by backpropagating the error through the artificial neural network.

The different machine learning modules M1 to M6 as well as MK can be designed as separate machine learning modules or can be designed as one, more or all of the machine learning modules M1 to M6 as well as MK can be executed collectively. In this case, the information exchanged between the modules, such as the context data packets K, can be latent variables.

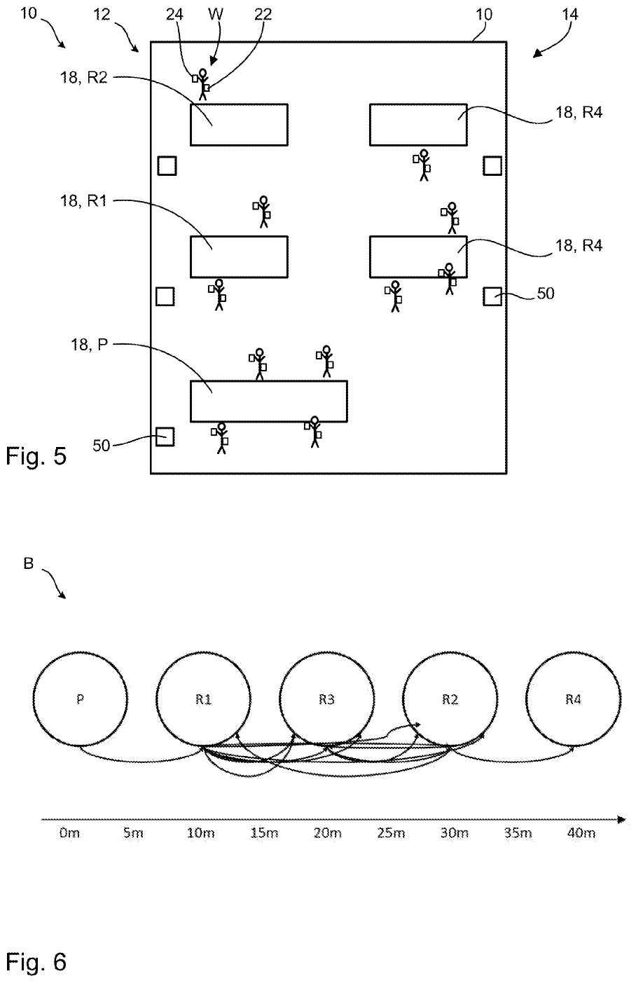

In FIG. 5, a second embodiment of the system 12 according to the disclosure, which is located in the factory building 10 again. For the sake of clarity, the monitoring system 16 is not shown.

The work system 14 of the system 12 acts in the second embodiment for despatching shipments.

For this purpose, the work system 14 as workstations 18 has four racks R1, R2, R3, R4, in which goods are stored, as well as a packing station P in which the collected goods are packed for distribution.

User W of the work system 14 have either the task to collect goods from the racks R1-R4 and to bring to the packing station P (what is termed a “picker”). The users W who pack the goods in cardboard boxes (referred to as “packers”) are divided into groups at the packing station P.

Accordingly, the process steps differ from each other which are executed by various users W so that the configuration of the sensor devices 24, in particular the sensor device 26, are different.

A user W who works as a “picker” starts at the packing station O and receives a contract to collect some good from the racks R1-R4.

For this purpose, the sensor device 26 of the user W is controlled in such a way by the control system 20 that the user W is instructed to go to a certain one of the racks R1-R4 in order to remove the good sought there. These instructions are received by the user W, for example, via the output means 30 of the sensor means 24, such as the screen of the sensor device 26.

At the start of each aisle for collecting goods, the user W reads a barcode, RFID, user input etc. with the sensor 28 at the packing station P that is attached there.

Arriving at one of the racks R1-R4, the user W reads a barcode by means of the sensor of the sensor drive, which identifies the rack and is attached to the corresponding racks R1-R4.

Subsequently, the user W removes the good sought after and reads the barcode found on the good.

After that the user W receives an instruction to go to another one of the racks R1-R4 in order to collect another good there.

These instructions repeat until the user W has finally collected all the goods being sought and has brought these to the packing station P. There, the user W reads the barcode again that is permanently attached to the packing station P.

In this procedure, the sensor means 24 generated a value or a string that is coded in the barcode in each reading process. The value or the string are transmitted as sensor data D to the control system 20. For simplification, “barcode” continues to be mentioned in the following. In addition, at least one event data packet E is also generated each time in this example and transmitted to the correlation module 52 of the monitoring system 16.

Moreover, the steps of the user W have been counted with the aid of an acceleration sensor as sensor 28 of the sensor means 24 when the user W is walking.

In this embodiment, the reading of a barcode that is attached permanently to the packing station P or to another one of the racks R1-R4 constitutes an event period in relation to the steps taken.

For each of the times of the events, the sensor means 24 creates an event data packet E that contains the number of steps since the last time of the event, thus the last reading of a barcode that is permanently attached to the packing station P or one of the racks R1-R4. The event data packet E is transmitted to the correlation module 52 and the analysis module 54.

The analysis module 54 transmits, for example, by means of the context machine learning module MK, the context information I whether the event data packet E or the barcode contained in the event data packet E is to be assigned to one of the racks R1-R4 or the packing station P or a good.

For example, using past event data packets E, the analysis module 54 recognises that a pair of barcodes that are different types has been read often in quick succession and after a break a pair of barcodes that are different types are read again in quick succession.

In doing so, the respective last barcodes read of a pair of chronologically successive pairs are often identical and the read barcodes initially differ. At the same time, the barcodes read initially are always barcodes from a group of only five barcodes.

On account of this pattern, the analysis module 54 can recognise that the barcodes read initially must be the barcodes of one of the racks R1-R4 or the packing station P and the barcodes of the pairs read last must be a barcode of the good. Thus, the first type of barcode read initially can be assigned to the racks R1-R4 or the packing station P and the type of barcode read last are the goods.

The connection is transmitted as context information I to the correlation module 52.

It is also conceivable that the analysis module 54 with the event data packets E contains the image recorded by the sensor and determines by means of image recognition whether the barcode read is found on a rack or the packing station or a good.

Further context information I can be generated by means of image recognition, for example whether the good is damaged, whether a transport container is full and/or whether a rack is empty.

For example, the analysis module 54 calculates based on the probabilities that the barcode that is permanently attached to the packing station P or one of the racks R1-R4 has the meaning that a packing station or racks are present. The barcodes must not be identified by a person beforehand and are provided with a label. As a result of the observation and the comparison of the recurring barcode, probabilities on the significance of the present barcode are generated. This dependency of the pairs on barcodes can be modelled as a conditional probability.

The correlation module 52 then links the event data packets E with further context information I, as previously described, and transmits the context records K that are thus formed to the analysis module 54.

By means of the previously determined context information I, the context records K now contain the information as to whether the event data packets E are assigned to the rack R1-R4 or the packing station P or the goods.

The analysis module 54 determines, for example, using the context records K that relate to the steps between the two workstations 18, the distance of the racks R1-R4 to each other and to the packing station P. In other words, the analysis module 54 determines the setup of the work system 14 without needing further information for this.

Moreover, the analysis module 54 can determine the most frequent routes taken between the racks R1-R4 and/or the packing station P.

The analysis module 54 can collate this information in a report B, for example in the form of a graphic, as shown in FIG. 6.

This shows the arrangement of the racks R1-R4 starting from the packing station P sorted solely according to the distance to the packing station P. Moreover, the most frequent routes are illustrated with arrows. This report B is therefore similar to what is termed a spaghetti diagram.

In addition, the analysis module 54 determines, for example, that the control system 20 in the intended process initially directs the user W to always collect goods from rack R1 first, then goods from rack R2, then from rack R3 and finally from rack R4 as rack 4 is located on the route between rack R2 and R3.

The analysis module 54 can thus identify as a system improvement C that the control system 20 adapts the process steps in such a way that the racks are visited in the sequence R1, R2, R4, R3 in order to avoid detours.

The analysis module 54 transmits this system improvement C to the distribution module 56. The distribution module 56 subsequently transmits a change order O to the control system 20 that the control system initiates accordingly.

It is also conceivable that connection devices 22 define the sequence of the racks R1, R2, R3, R4 to be visited by the user W as a result of on general instructions from the control system 20.

In this case, the distribution module 56 sends a corresponding change order O to the connection devices 22 of the user W, who is working a picker, to change the sequence in which the racks are visited.

In this way, the monitoring system 16 improves the work system 14 directly.

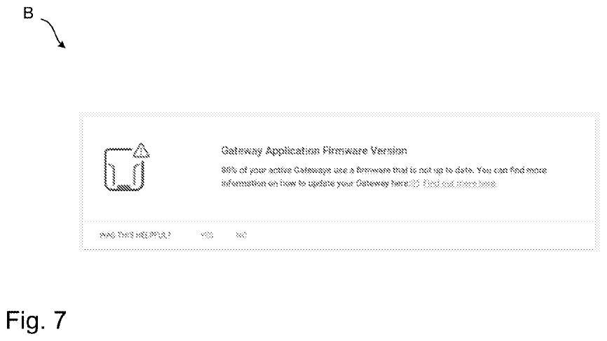

In FIG. 7, a further example of a report B is shown as it, for example, is displayed on the screen of a smart device of the supervisor.

This report B is text based and explains to the user W that 66.67% of the sensor means 24 (“scanner”) active in the work system 14 use a firmware that is not up-to-date and offers further information via a link that the supervisor can select.

The report B has been created using a report template V. The report template V can contain one or more of the following conditions, specifications and parameters: an identifier identifying the report template V; conditions needing to be fulfilled in order to generate a report B using this report template V; an expected reference value that has be determined by the analysis module 54 as to whether the report B will be relevant; the current value for the reference value; a relational operator whether the current value must be larger, the same or smaller in order to generate the report B using this report template V; information on the presentation method of the report B; an identifier of the presentation method, the type of presentation (e.g. text only, text with graphics, text with a table, other detail, etc.); parts of the display, e.g. sentences in which actual values can be inserted, e.g. from the sensor data, when being created; information regarding the expected relevance; information on the data source of the values used; a name of the report template V; a rule whether the values used represent a positive, neutral or negative trend; an identifier of said one user W or several users W who are to receive the report B.

The text displayed of other reports can be for example: “A barcode is often scanned at the location “Rack 5” but for this frequency the location is very far away.” “You should reduce the distance to this location” or “Barcodes that are QR codes are read into the work system most quickly. “Use this type more often!”

Moreover, in the example of FIG. 7, it has been inquired whether the following report B was helpful. The user W can now answer with “yes” or “no” and thus provide feedback on whether this report B was relevant to the user W.

Using this feedback, the relevance of the report B can be assessed by the analysis module 54 better. In particular based on the feedback, the third machine learning module M4 of the analysis module 54 adapts constantly. In this way, the user W is only shown reports B over time that are relevant and supported by the user W.

1. A method for monitoring a work system comprising a plurality of sensor means with at least a sensor and a control system, wherein the method comprises steps of:
creating sensor data as well as event data packets by means of the plurality of sensor means during operation by a user,
transmitting the event data packets to a correlation module of a monitoring system,
receiving context information by means of the correlation module,
correlating the event data packets with the context information by means of the correlation module and creating context records by means of the correlation module, said context records being based on the event data packets correlated with the context information,
transmitting the context records to an analysis module, and
creating a report, at least one of the report being on at least one of on a state of the work system or deviations from a previous operating sequence of the work system; or the report comprising a system improvement by the analysis module based on the context records.

2. The method according to claim 1, wherein the control system controls the plurality of sensor means at least in part for a purpose of executing a process assigned to a corresponding sensor means.

3. The method according to claim 1, wherein at least one of said at least one sensor of the plurality of sensor means is at least one of a camera, a barcode reader or an acceleration sensor, or
the sensor means comprises at least one actuating element, or
the sensor means comprises at least one output means.

4. The method according to claim 1, wherein the work system comprises a plurality of connection devices, wherein each connection device is connected to one or more of the sensor means via a wireless communication link and is connected to the control system via a wired or wireless communication link or is configured on a same sensor means.

5. The method according to claim 4, wherein the connection devices create the event data packets and transmit the event data packets to the correlation module.

6. The method according to claim 1, wherein an event data packet is at least one of created at regular intervals by the sensor means or is then created if there is a trigger event and includes information on the trigger event.

7. The method according to claim 1, wherein the event data packet comprises current sensor data of at least one sensor of the sensor means as well as at least one situation information of the sensor means.

8. The method according to claim 1, wherein at least one of the report contains at least one of information on a setup of the work system as the state of the work system; a utilisation of the work system; the state of at least one of sensor means, gateways or connection devices; at least one process executed with the work system; a discharge rate of a storage battery or a primary battery of the sensor means; a storage battery life or primary battery life; a type of barcode read; a duration of a reading process; a success of the reading process; a number of steps between two reading processes; a change in a location between two reading processes; a software version of the sensor means; the software version of the connection devices; or information regarding a charging behavior of the sensor means; or
the report as the deviations from the previous operating sequence contains at least one of information of the sensor means comprising more or less executed process steps as the previous operating sequence; changes to the setup of the work system; changes to the utilisation of the work system; changes to the state of the work system; changes to said at least one process executed with the work system; differences between same processes at at least one of different locations or different workstations; or differences regarding industry reference values.

9. The method according to claim 1, wherein at least one of the context records or the event data packets are stored in a storage device to be used at a later date as past context records or past event data packets, respectively.

10. The method according to claim 1, wherein at least one of the correlation module contains at least one of the context information from the control system, an inventory management system, an enterprise resource planning system, a machine controller for a machine of the work system, a mobile device management system, data from external data providers, or publicly accessible data sources; or
wherein the context information comprises at least one of information regarding a working environment, processes of the work system, users of the work system or regarding a utilisation of the work system.

11. The method according to claim 1, wherein the report is transmitted to at least one of the control system, an inventory management system, an enterprise resource planning system, a mobile end device, a workplace computer or an output means.

12. The method according to claim 1, wherein the analysis module receives the event data packets as well as creates the context information for the event data packets based on at least one of the event data packets or past event data packets and transmits this to the correlation module.

13. The method according to claim 1, wherein the analysis module determines at least one system improvement based on at least one of the context records or the report.

14. The method according to claim 1, wherein the following steps are executed for creating the report:
determining at least one of the state of the work system, the previous operating sequence, or the deviations from the previous operating sequence on a basis of the context records, and
creating the report using at least one of the state of the work system, the previous operating sequence or deviations from the previous operating sequence.

15. The method according to claim 14, wherein a first machine learning module of the analysis module is used to determine at least one of the state of the work system, the previous operating sequence or deviations from the previous operating sequence.

16. The method according to claim 1, wherein the system improvement is transmitted to a distribution module, wherein the distribution module creates at least one change order based on the system improvement for at least one of the sensor means and transmits the change order to at least one of the respective sensor means, a connection device corresponding to the respective sensor means, or the control system.

17. The method according to claim 16, wherein the sensor means outputs an action order to the user on a basis of the change order.

18. The method according to claim 16, wherein at least one of the control system or the corresponding connection device at least one of changes a process assigned to the corresponding sensor means based on the system improvement or instructs the sensor means to output an action order.

19. The method according to claim 1, wherein at least one of a machine learning module of the correlation module, a first machine learning module of the analysis module, a second machine learning module of the analysis module, a third machine learning module of the analysis module, a fourth machine learning module of the analysis module, a context machine learning module of the analysis module, or a machine learning module of a distribution module is or comprises at least one of an artificial neural network, a decision tree, a statistical algorithm, a cluster algorithm, a module for generating text, or a principal component analysis.

20. A system comprising a work system and a monitoring system, wherein the system is configured to execute a method comprising steps of:
creating sensor data as well as event data packets by means of a plurality of sensor means during operation by a user,
transmitting the event data packets to a correlation module of a monitoring system,
receiving context information by means of the correlation module,
correlating the event data packets with the context information by means of the correlation module and creating context records by means of the correlation module, said context records being based on the event data packets correlated with the context information,
transmitting the context records to an analysis module, and
creating a report, at least one of the report being on at least one of a state of the work system or on deviations from a previous operating sequence of the work system, or the report comprising a system improvement by the analysis module based on the context records.
